(19) United States
(12) Patent Application Publication
(10) Pub. No.: US 2025/0184285 A1
(43) Pub. Date: Jun. 5, 2025

(54) User Plane Traffic Characteristics in a Communication Network

(71) Applicant: Telefonaktiebolaget LM Ericsson (publ), Stockholm (SE)

(72) Inventors: Paul Schliwa-Bertling, Ljungsbro (SE); Yazid Lyazidi, London (GB); Nianshan Shi, Järfälla (SE); Jose Luis Pradas, Stockholm (SE)

(21) Appl. No.: 18/840,720

(22) PCT Filed: Feb. 23, 2023
(86) PCT No.: PCT/EP2023/054572

§ 371 Date: Aug. 22, 2024

Related U.S. Application Data
(60) Provisional application No. 63/313,088, filed on Feb. 23, 2022.

(51) Int. Cl. H04L 47/80; H04L 47/24

(52) U.S. Cl. CPC H04L 47/805; H04L 47/24

(57) ABSTRACT

A method performed by a network node (10-1, 10-2) in a communication network (10) is disclosed. The network node (10-1, 10-2) transmits or receives (1100) messages (M) through a tunnel (T) with another network node (10-1, 10-2). In some embodiments, the messages (M) convey user plane traffic (14). In some embodiments, one or more of the messages (M) each include information (16) indicating one or more characteristics of the user plane traffic (14). In some embodiments, the one or more characteristics include a periodicity of the user plane traffic (14) and/or a burst arrival time of the user plane traffic (14).

### TECHNICAL FIELD

The present application relates generally to a communication network and relates more particularly to user plane traffic characteristics in such a network.

### BACKGROUND

When setting up a packet data unit (PDU) session for time-sensitive communication (TSC) in a 5G communication network, the PDU session can be tailored to the periodicity and/or burst arrival time of the TSC. The PDU session management procedures therefore include signaling between network nodes indicating the TSC periodicity and/or burst arrival time.

Challenges exist, however, for tailoring the PDU session for some types of TSC where the periodicity and/or burst arrival time can vary dynamically. For extended Reality (XR) traffic, for example, the periodicity and/or burst arrival time can vary quite frequently and therefore need to be signaled frequently as part of the PDU session management procedure. Frequent variation in the periodicity and/or burst arrival time proves problematic, though, given the overhead involved in the PDU session management procedure. This procedure is more onerous than desirable in terms of signaling overhead, especially for frequent changes, where many interfaces need to be instantiated and much hand-shake signaling needs to be exchanged.

### SUMMARY

Some embodiments herein indicate user plane traffic characteristic(s) in-band with the user plane traffic, e.g., XR traffic. In some embodiments, for example, the same message that conveys user plane traffic also includes information indicating one or more characteristics of the user plane traffic, e.g., the periodicity and/or burst arrival time of the user plane traffic. Signaling the user plane traffic characteristic(s) in-band in this way advantageously provides more frequent opportunities to signal the characteristic(s), e.g., as frequent as every user plane traffic packet if needed, without the added procedural overhead required to signal the characteristic(s) out-of-band. For XR traffic whose periodicity and/or burst arrival time varies frequently, then, some embodiments signal XR traffic periodicity and/or burst arrival time in-band with the user plane data, e.g., rather than (or in addition to) a PDU session management procedure.

Other embodiments herein alternatively or additionally indicate user plane traffic characteristic(s) in uplink signaling, e.g., in an RRC message.

More particularly, some embodiments herein include a method performed by a network node in a communication network. The method comprises transmitting or receiving messages through a tunnel with another network node. In some embodiments, the messages convey user plane traffic. In some embodiments, one or more of the messages each include information indicating one or more characteristics of the user plane traffic.

In some embodiments, the one or more characteristics include a periodicity of the user plane traffic.

Alternatively or additionally, in some embodiments, the one or more characteristics include a burst arrival time of the user plane traffic.

In some embodiments, the one or more characteristics are one or more time-sensitive communication, TSC, characteristics.

In some embodiments, the messages convey user plane traffic for one or more flows. In some embodiments, information included in a message conveying user plane traffic for a flow indicates one or more characteristics of the user plane traffic for that flow. In one or more of these embodiments, the user plane traffic is extended Reality, XR, traffic, wherein the one or more flows are one or more XR traffic flows.

In some embodiments, the tunnel is a GTP-U tunnel. In one or more of these embodiments, the one or more messages each include the information indicating one or more characteristics of the user plane traffic in a GTP-U extension header.

In some embodiments, the one or more messages each include the information indicating one or more characteristics of the user plane traffic in a DL PDU SESSION INFORMATION frame.

In some embodiments, the one or more messages each include the information indicating one or more characteristics of the user plane traffic in a DL USER DATA frame.

In some embodiments, the one or more messages each include the information indicating one or more characteristics of the user plane traffic in a DL DATA DELIVERY STATUS frame.

In some embodiments, said transmitting or receiving comprises transmitting the messages. In one or more of these embodiments, the network node is a core network node, and the another network node is a radio network node. In one or more of these embodiments, the core network node implements a User Plane Function, UPF. In one or more of these embodiments, the network node comprises a central unit of a radio network node and the another network node comprises a distributed unit of the radio network node.

In some embodiments, said transmitting or receiving comprises receiving the messages. In one or more of these embodiments, the another network node is a core network node, and the network node is a radio network node. In one or more of these embodiments, the core network node implements a User Plane Function, UPF. In one or more of these embodiments, the another network node comprises a central unit of a radio network node and the network node comprises a distributed unit of the radio network node. In one or more of these embodiments, the method further comprises, based on the one or more indicated characteristics of the user plane traffic, adapting allocation of radio resources for the user plane traffic and/or adapting a configuration of a communication device associated with the user plane traffic.

In some embodiments, the one or more messages each further include a quality of service, QoS, flow identifier identifying a QoS flow to which the message or the user plane traffic conveyed by the message belongs.

In some embodiments, the one or more messages each further include other information indicating one or more requirements for conveying the user plane traffic. In one or more of these embodiments, the messages convey user plane traffic for one or more QoS flows. In some embodiments, other information included in a message conveying user plane traffic for a QoS flow indicates the one or more requirements for conveying the user plane traffic for that QoS flow. In one or more of these embodiments, the other information included in a message conveying user plane traffic for a QoS flow indicates the one or more requirements for conveying the user plane traffic for that QoS flow by indicating an identifier of that QoS flow.

In some embodiments, the messages are downlink messages.

Other embodiments herein include a method performed by a communication device in a communication network. The method comprises transmitting uplink signaling indicating one or more characteristics of user plane traffic.

In some embodiments, the one or more characteristics include a periodicity of the user plane traffic.

Alternatively or additionally, in some embodiments, the one or more characteristics include a burst arrival time of the user plane traffic.

In some embodiments, the uplink signaling is transmitted in a radio resource control, RRC, message. In one or more of these embodiments, the RRC message is a UE Assistance message.

In some embodiments, the one or more characteristics include one or more characteristics at an application layer.

In some embodiments, the method further comprises obtaining the one or more characteristics from an application layer.

In some embodiments, the one or more characteristics are one or more time-sensitive communication, TSC, characteristics.

In some embodiments, the uplink signaling indicates one or more characteristics of user plane traffic for each of one or more flows. In one or more of these embodiments, the one or more flows are one or more XR traffic flows.

Other embodiments herein include a method performed by a network node in a communication network. The method comprises transmitting or receiving uplink signaling indicating one or more characteristics of user plane traffic.

In some embodiments, the one or more characteristics include a periodicity of the user plane traffic.

Alternatively or additionally, in some embodiments, the one or more characteristics include a burst arrival time of the user plane traffic.

In some embodiments, said transmitting or receiving comprises receiving the uplink signaling. In one or more of these embodiments, the uplink signaling is received from a communication device.

In some embodiments, the uplink signaling is received in a radio resource control, RRC, message. In one or more of these embodiments, the RRC message is a UE Assistance message.

In some embodiments, said transmitting or receiving comprises transmitting the uplink signaling. In one or more of these embodiments, the uplink signaling is transmitted to another network node.

In some embodiments, the one or more characteristics include one or more characteristics at an application layer.

In some embodiments, the method further comprises obtaining the one or more characteristics from an application layer.

In some embodiments, the one or more characteristics are one or more time-sensitive communication, TSC, characteristics.

In some embodiments, the uplink signaling indicates one or more characteristics of user plane traffic for each of one or more flows. In one or more of these embodiments, the one or more flows are one or more XR traffic flows.

In some embodiments, the method further comprises, based on the one or more characteristics of user plane traffic, adapting allocation of radio resources for the user plane traffic and/or adapting a configuration of the communication device associated with the user plane traffic.

Embodiments herein further include corresponding apparatus, computer programs, and carriers of those computer programs.

### BRIEF DESCRIPTION OF THE DRAWINGS

FIG. 1 is a block diagram of a communication network in accordance with some embodiments

FIG. 2 is a line chart of an example of frame latency measured over a radio access network (RAN), excluding application and core network latencies, according to some embodiments.

FIG. 3 is a line chart of an example of the cumulative distribution functions of the number of transport blocks required to deliver a video frame with size ranging from 20 KB to 300 KB according to some embodiments.

FIG. 4 is a block diagram of a user plane interface for the NG user plane according to some embodiments.

FIG. 5 is a block diagram of a user plane interface for the NG user plane according to some embodiments for dual connectivity.

FIG. 6 is a block diagram of an architecture for separation of gNB-CU-CP and gNB-CU-UP according to some embodiments.

FIG. 7 is a block diagram of a protocol stack for a GTP Protocol Data Unit (PDU) (GTP-PDU) according to some embodiments.

FIG. 8 is a block diagram of a protocol stack for a GTP-PDU signaling message according to some embodiments.

FIG. 9 is a block diagram of fields which consist of multiple bits within an octet have the most significant bit located at the higher bit position according to some embodiments.

FIG. 10 is a logic flow diagram of a method performed by a communication device according to some embodiments.

FIG. 11 is a logic flow diagram of a method performed by a network node according to some embodiments.

FIG. 12 is a logic flow diagram of a method performed by a network node according to other embodiments.

FIG. 13 is a block diagram of a communication device according to some embodiments.

FIG. 14 is a block diagram of a network node according to some embodiments.

FIG. 15 is a block diagram of a communication system in accordance with some embodiments

FIG. 16 is a block diagram of a user equipment according to some embodiments.

FIG. 17 is a block diagram of a network node according to some embodiments.

FIG. 18 is a block diagram of a host according to some embodiments.

FIG. 19 is a block diagram of a virtualization environment according to some embodiments.

FIG. 20 is a block diagram of a host communicating via a network node with a UE over a partially wireless connection in accordance with some embodiments.

### DETAILED DESCRIPTION

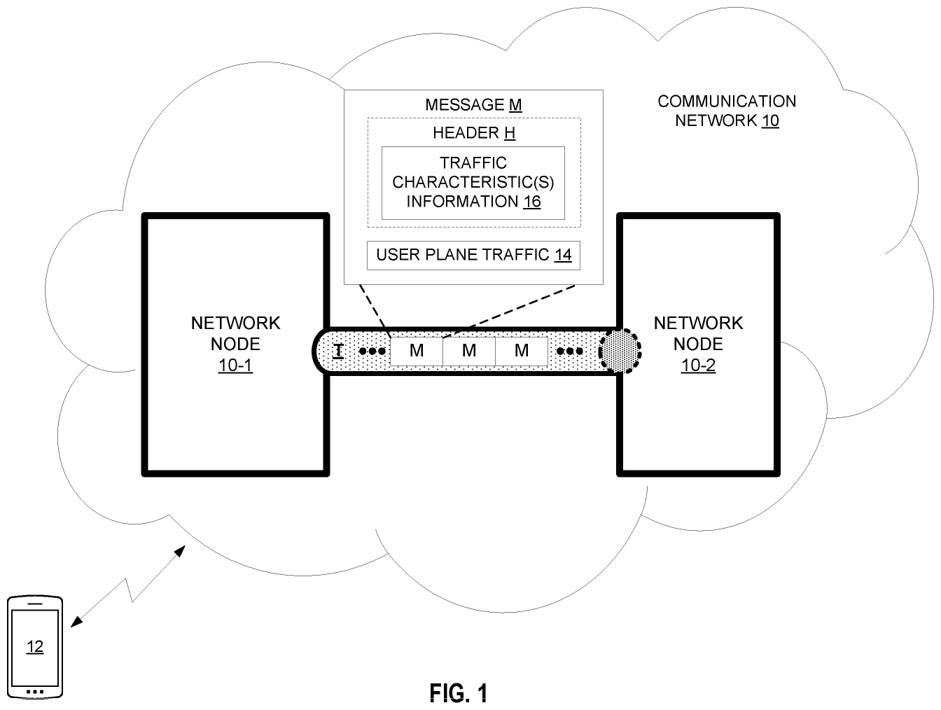

FIG. 1 shows a communication network 10 configured to provide communication service to a communication device 12. The communication network 10 may for instance be a wireless communication network, such as a 5G wireless communication network, in which case the communication device 12 may be a wireless communication device. Regardless, the communication network 10 as shown includes network nodes 10-1 and 10-2 for providing communication service to the communication device 12. The network nodes 10-1, 10-2 in particular are each in a path via which user plane (UP) traffic for the communication device 12 is communicated, e.g., extended Reality (XR) traffic. User plane traffic herein refers to traffic in a user plane of the communication network 10, where the user plane contains protocols responsible for transporting the traffic, as opposed to the control plane which contains protocols responsible for controlling how the traffic is transported.

FIG. 1 in this regard shows that user plane traffic 14 is communicated between the network nodes 10-1, 10-2 via a tunnel T. The tunnel T may for instance be a point-to-point tunnel, such as a General Packet Radio Service (GPRS) Tunnelling Protocol (GTP) user plane (GTP-U) tunnel. Alternatively or additionally, one or more quality of service (QOS) flows for the communication device 12 may be mapped to and/or bundled inside the tunnel T. In some embodiments, the user plane traffic 14 communicated through the tunnel T is the user plane traffic for a Protocol Data Unit (PDU) session, e.g., wherein the PDU session provides connectivity between application(s) on the communication device 12 and a data network (DN). In this case, the PDU session in some 5G embodiments is associated with a single DN name (DNN) and with a single network slice.

In any event, the user plane traffic 14 for the communication device 12 may be packetized into one or more messages M, e.g., downlink messages in a direction towards the communication device 12. In these and other embodiments, the user plane traffic 14 for the communication device 12 is conveyed by messages M communicated through the tunnel T, which may for instance be dedicated for communicating user plane traffic for the communication device 12. As shown in FIG. 1, then, network nodes 10-1, 10-2 transmit and/or receive messages M through the tunnel T, where those messages M convey user plane traffic 14.

Notably, according to some embodiments herein, one or more of the messages M each include information 16 indicating one or more characteristics of the user plane traffic 14, e.g., the periodicity of the user plane traffic 14, the burst arrival time of the user plane traffic 14, and/or other time-sensitive communication (TSC) characteristic(s). The information 16 as shown may therefore conveniently be referred to as traffic characteristic(s) information 16. The traffic characteristic(s) information 16 is therefore communicated in-band with the user plane traffic 14, since the traffic characteristic(s) information 16 indicating characteristic(s) of the user plane traffic 14 is included in the same message M as that user plane traffic 14. As shown in FIG. 1, for example, a message M that conveys user plane traffic 14 (as the message payload) has a header H that includes the traffic characteristic(s) information 16. In some embodiments where the tunnel is a GTP-U tunnel, for example, the information 16 may be included in a GTP-U extension header. Alternatively or additionally, as elaborated more fully later, the information 16 may be included in a DL PDU SESSION INFORMATION frame, a DL USER DATA frame, or a DL DATA DELIVERY STATUS frame.

Regardless, signaling the user plane traffic characteristic(s) in-band in this way advantageously provides more frequent opportunities to signal the characteristic(s), e.g., as frequent as every message M if needed, without the added procedural overhead required to signal the characteristic(s) out-of-band. For XR traffic whose periodicity and/or burst arrival time varies frequently, then, some embodiments signal XR traffic periodicity and/or burst arrival time in-band with the user plane traffic 14, e.g., rather than (or in addition to) a PDU session management procedure.

In some embodiments, user plane traffic 14 communicated through the tunnel T may belong to any one of one or more flows, e.g., XR traffic flow(s) and/or QoS flow(s). In such embodiments, the traffic characteristic(s) information 16 may be common to multiple flows, i.e., such that the information 16 indicates characteristic(s) that characterize user plane traffic 14 belonging to any of those multiple flows. In other embodiments, by contrast, the traffic characteristic(s) information 16 is flow-specific so as to indicate characteristic(s) of the user plane traffic 14 for a specific flow. In this case, then, information 16 included in a message M conveying user plane traffic 14 for a specific flow indicates one or more characteristics of the user plane traffic 14 for that specific flow.

Note in this regard that the traffic characteristic(s) herein may characterize the user plane traffic 14 actually conveyed, e.g., as actually measured or experienced at an application layer. The traffic characteristic(s) thereby differ from traffic requirement(s) that specify requirements that the user plane traffic 14 must meet, e.g., in order to have a certain quality of service. The traffic characteristic(s) may accordingly differ from QoS flow descriptions or parameters that describe requirements for a QoS flow to which the user plane traffic 14 belongs. In this case, then, the traffic characteristic(s) information 16 differs from any QoS flow identifier that identifies a QoS flow to which the user plane traffic 14 belongs and therefore indirectly indicates requirements for the QoS flow. In fact, in some embodiments, a message M may include (i) a QoS flow identifier effectively indicating requirements for a QoS flow and (ii) traffic characteristic(s) information 16 indicating characteristic(s) of user plane traffic 14 belonging to that QoS flow.

Note that, in one or more embodiments, one of the network nodes 10-1, 10-2 is deployed in an access network of the communication network 10 and the other of the network nodes 10-1, 10-2 is deployed in a core network of the communication network 10. In these and other embodiments, where the communication network 10 is a 5G network, whichever of the network nodes 10-1, 10-2 is in the access network may be a gNodeB and the other of the network nodes 10-1, 10-2 in the core network may implement a user plane function (UPF).

In some embodiments, the recipient of the messages M uses the traffic characteristic(s) information 16 for adapting allocation of radio resources for the user plane traffic 14 and/or for adapting a configuration of the communication device 12 associated with the user plane traffic 14. Such adaptation may for instance tailor radio resource allocation and/or communication device configuration as needed to accommodate any changes in the user plane traffic periodicity and/or burst arrival time.

Some embodiments herein are applicable in the following context where the communication network 10 is exemplified as a 5G communication network, the communication device 12 is exemplified as a user equipment (UE), the tunnel T is exemplified as a GTP-U tunnel, the user plane traffic 14 is exemplified as XR traffic, and the traffic characteristic(s) indicated by the traffic characteristic(s) information 16 include periodicity and/or burst arrival time.

More particularly in this regard, 5G is the fifth-generation of mobile communications, addressing a wide range of use cases, from enhanced mobile broadband (eMBB) to ultra-reliable low-latency communications (URLLC) to massive machine type communications (mMTC). 5G includes the New Radio (NR) access stratum interface and the 5G Core Network (5GC).

Low-latency high-rate applications such as extended Reality (XR) and cloud gaming are important in the 5G era. XR may refer to all real-and-virtual combined environments and human-machine interactions generated by computer technology and wearables. It is an umbrella term for different types of realities including Virtual reality (VR), Augmented reality (AR), Mixed reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks. See, e.g., 3GPP TS 38.413 V16.8.0.

### Low-Latency High-Rate Applications

Some embodiments herein are applicable to user plane traffic for low-latency high-rate applications as described below.

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

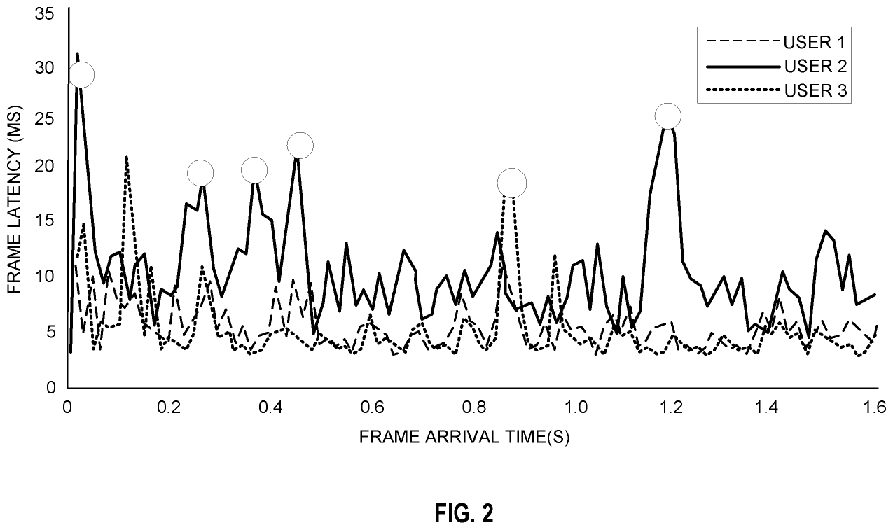

FIG. 2 shows an example of frame latency measured over a radio access network (RAN), excluding application and core network latencies. It can be seen that there exist frame latency spikes in the RAN. The latency spike occurs due to instantaneous shortage of radio resources or inefficient radio resource allocation in response to varying frame size. The sources for the latency spikes may include queuing delay, time-varying radio environments, and time-varying frame sizes, among others. Tools that can help to remove latency spikes are beneficial to enable better 5G support for this type of traffic.

In addition to bounded latency requirements, the applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

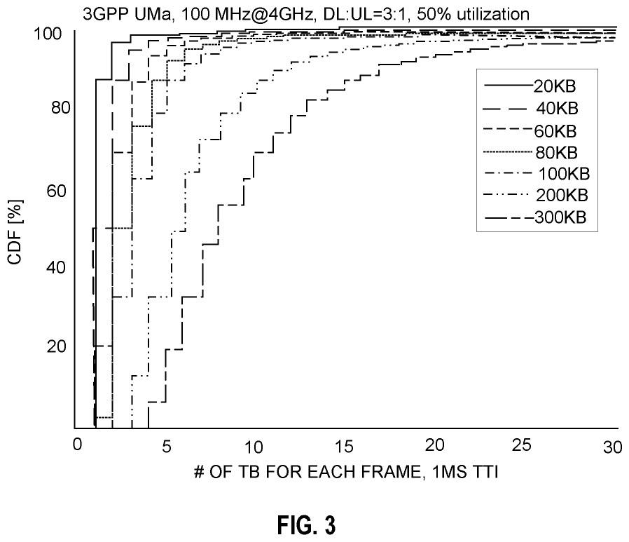

A large video frame is usually fragmented into smaller Internet Protocol (IP) packets and transmitted as several transport blocks (TBs) over several transmission time intervals (TTIs) in the RAN. FIG. 3 shows an example of the cumulative distribution functions of the number of transport blocks required to deliver a video frame with size ranging from 20 KB to 300 KB. For example, FIG. 3 shows that for delivering the frames with a size of 100 KB each, the median number of needed transport blocks (TBs) is 5.

### User Plane Interfaces

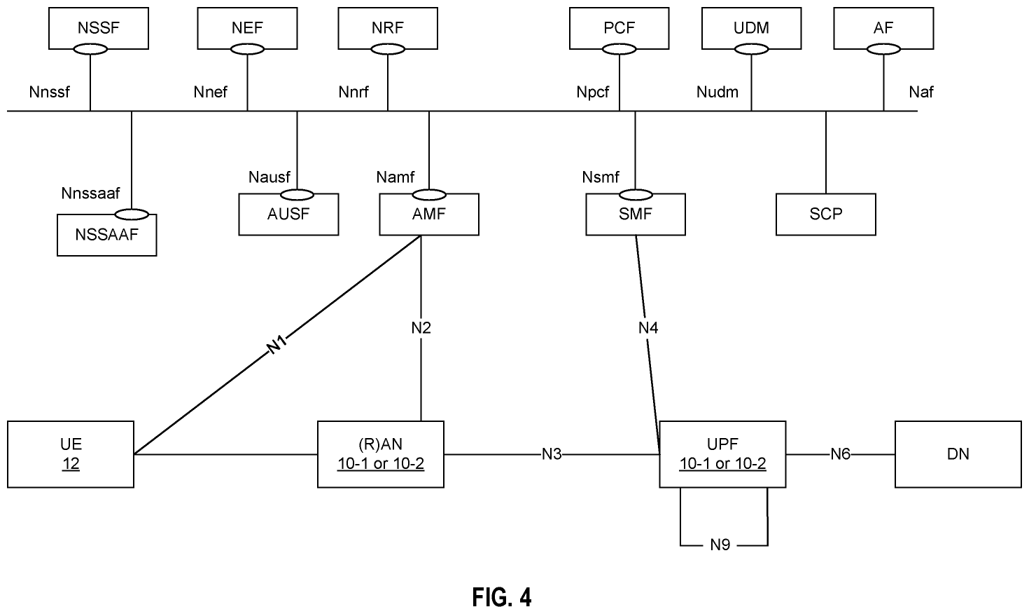

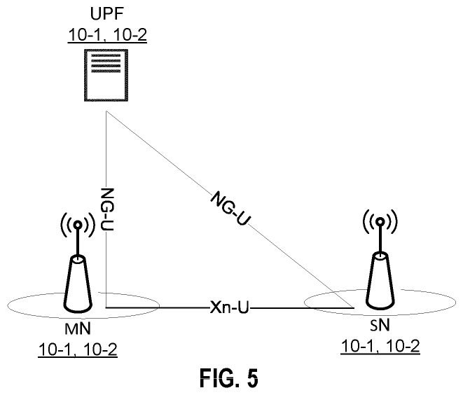

FIG. 4 and FIG. 5 shows the user plane interfaces for the NG-U (sometimes referred to as the N3) interface between the user plane function (UPF) and the NG-RAN as well as the Xn-U between two NG-RAN nodes according to some embodiments where the communication network 10 is a 5G network.

In particular, FIG. 4 shows the communication device 12 in FIG. 1 exemplified as a user equipment (UE) 12, one of the network nodes 10-1, 10-2 in FIG. 1 exemplified as a node in a (radio) access network ((R)AN), and the other of the network nodes 10-1, 10-2 in FIG. 1 exemplified as a node implementing the UPF. The UPF is shown as connecting the UE 12 to a data network (DN), e.g., the Internet. In this case, then, the messages M in FIG. 1 are messages transmitted over the NG-U or N3 interface between the (R)AN and the UPF.

FIG. 5 shows another view of the NG-U interface in a dual connectivity context including a master node (MN) and a secondary node (SN) for dual connectivity operation. In this case, one of the network nodes 10-1, 10-2 in FIG. 1 is exemplified as the MN or SN, and the other of the network nodes 10-1, 10-2 in FIG. 1 is exemplified as a node implementing the UPF. Accordingly, the messages M in FIG. 1 are messages transmitted over the NG-U interface between the MN and the UPF, or between the SN and the UPF.

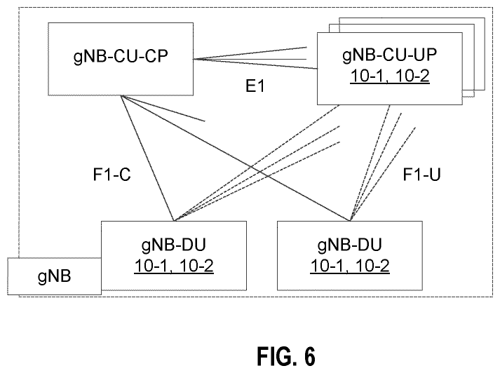

FIG. 6 depicts other embodiments where the communication network 10 employs an architecture for separation of gNB-CU-CP and gNB-CU-UP. Here, the gNB is a radio network node that is distributed between a central unit (CU) and one or more distributed units (DUs), and that is separated between the user plane (UP) and the control plane (CP). The gNB-CU-UP as shown is connected to the gNB-DU through the F1-U interface. In this case as shown, one of the network nodes 10-1, 10-2 in FIG. 1 is exemplified as the gNB-CU-UP, and the other of the network nodes 10-1, 10-2 in FIG. 1 is exemplified as a gNB-DU. Accordingly, the messages M in FIG. 1 are messages transmitted over the F1-U interface between the gNB-CU-UP and a gNB-DU.

Generally, then, some embodiments are applicable for the GTP-Uv1 as otherwise specified in TS 29.281 V17.1.0, for use on the N3/NG-U interface between the UPF and the NG-RAN/CU-UP and/or on the F1-U interface between the CU-UP and the DU and the CU-UPs configured with different NG-RAN/gNBs where Xn-U is established. Except as specified herein, other details on the content of the GTP-U headers are specified in TS 38.415 V16.6.0 for the NG-U/N3 and in TS 38.425 V16.3.0 for the F1-U and XN-U interface.

### GTP Header in UPF

Some embodiments herein are applicable to GTP-U protocol entities which may provide packet transmission and reception services to user plane entities in the radio network controller (RNC), Serving GPRS Support Node (SGSN), Gateway GPRS Support Node (GGSN), eNodeB, Serving Gateway (SGW), evolved Packet Data Gateway (ePDG), Packet Gateway (PGW), Trusted Wireless Local Area Network (TWAN), Mobility Management Entity (MME), gNB, Non-3GPP Interworking Function (N3IWF), and UPF. The GTP-U protocol entity receives traffic from a number of GTP-U tunnel endpoints and transmits traffic to a number of GTP-U tunnel endpoints. There is a GTP-U protocol entity per IP address.

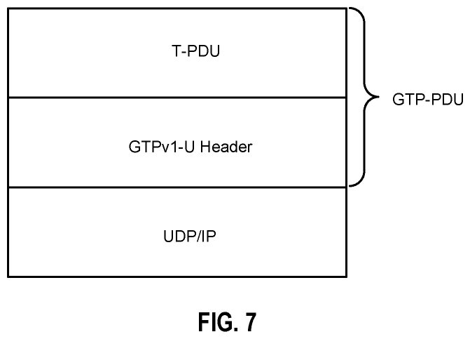

In some embodiments, the protocol stack for a GTP Protocol Data Unit (PDU) (GTP-PDU) is as shown in FIG. 7, e.g., according to 3GPP TS 29.281 v17.1.0. In this case, a GTP-PDU includes a Transport PDU (T-PDU) and a GTPv1-U Header. The GTP-PDU encapsulates the T-PDU as the payload that is tunneled in the GTP-U tunnel, e.g., where the payload is user plane traffic. A T-PDU in this regard may contain an IP Datagram, Ethernet or unstructured PDU Data frames, e.g., as specified in 3GPP TS 23.501 v17.3.0. The GTPv1-U Header is the header added by GTP-U for tunnelling the T-PDU, e.g., including the in-band traffic characteristic(s) information 16 in FIG. 1. Regardless, the GTP-PDU may use the IP protocol or the User Datagram Protocol (UDP) for the underlying transport.

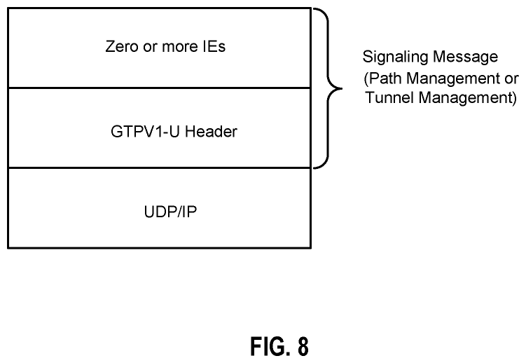

The protocol stack for a GTP-PDU signaling message is shown in FIG. 8 according to some embodiments. The signaling message may be for path management or tunnel management, for example. The signaling message as shown includes zero or more information elements (IEs) encapsulated by a GTPV1-U Header. The signaling message may similarly use the IP protocol or the User Datagram Protocol (UDP) for the underlying transport.

In some embodiments, the GTP-U header used herein is structured according to 3GPP TS 29.281 v17.1.0 except as specified otherwise herein. It is a variable length header whose minimum length is 8 bytes. There are three flags that are used to signal the presence of additional optional fields: the PN flag, the S flag, and the E flag. The PN flag is used to signal the presence of N-PDU Numbers. The S flag is used to signal the presence of the GTP Sequence Number field. The E flag is used to signal the presence of the Extension Header field, used to enable future extensions of the GTP header defined in this document, without the need to use another version number. If and only if one or more of these three flags are set, the fields Sequence Number, N-PDU, and Extension Header shall be present. The sender shall set all the bits of the unused fields to zero. The receiver shall not evaluate the unused fields. For example, if only the E flag is set to 1, then the N-PDU Number and Sequence Number fields shall also be present, but will not have meaningful values and shall not be evaluated.

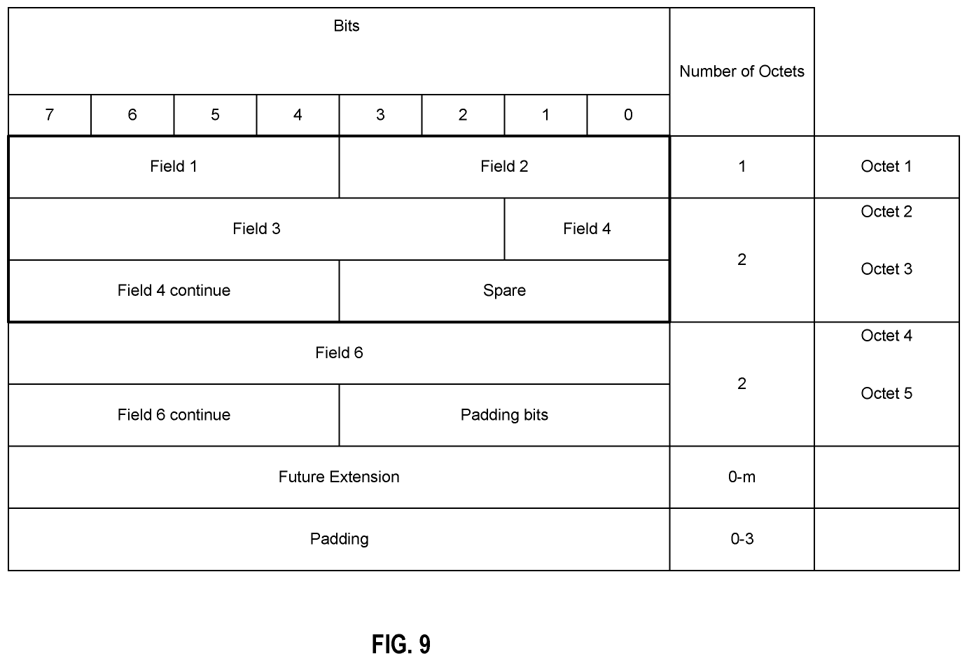

The PDU session user plane protocol data is conveyed by GTP-U protocol means, more specifically, by means of the “GTP-U Container” GTP-U Extension Header, e.g., as defined in TS 29.281 v17.1.0. In some embodiments, the structure of frames is specified by using figures similar to FIG. 9, e.g., according to TS 38.415 v16.6.0.

Unless otherwise indicated, fields which consist of multiple bits within an octet have the most significant bit located at the higher bit position (indicated in FIG. 9). In addition, if a field spans several octets, most significant bits are located in lower numbered octets (right of frame in FIG. 9).

In some embodiments, on the NG-U interface, the frame is transmitted starting from the lowest numbered octet. Within each octet, the bits are sent according to decreasing bit position (bit position 7 first).

Spare bits should be set to “0” by the sender and should not be checked by the receiver.

In some embodiments, the header part of the frame is always an integer number of octets. The payload part is octet aligned (by adding ‘Padding Bits’ when needed).

In some embodiments, the receiver should be able to remove an additional Future Extension field that may be present. Table A.1-1 shows one example description of a Future Extension field according to some embodiments.

TABLE A.1-1
Example of future Extension Field

| New | New | New | New | New | New | New | New | |
|---|---|---|---|---|---|---|---|---|
| IE | IE | IE | IE | IE | IE | IE | IE | 1 Octet |
| flag | flag | flag | flag | flag | flag | flag | flag | New IE |
| 7(E) | 6 | 5 | 4 | 3 | 2 | 1 | 0 | Flags |

| | |
|---|---|
| New IE 1 | 3 Octets |
| New IE 2 | 2 Octets |

In the Example of the future Extension Field, New IE flag 0 indicates if the New IE 1 is present or not. New IE flag 1 indicates if the new IE 2 is present or not, etc.

### A.1.1 New IE Flags

Description: The New IE Flags IE is only present if at least one new IE is present. The New IE Flags IE contains flags indicating which new IEs that are present following the New IE Flags IE. The last bit position of the New IE Flags IE is used as the Extension Flag to allow the extension of the New IE Flags IE in the future. Extension octets of the New IE Flags IE shall follow directly after the first octet of the New IE Flags IE. When an extension octet of the New IE Flags IE is present, then all previous extension octets of the New IE Flags IE and the New IE Flags IE shall also be present, even if they have all their flag bits indicating no presence of their respective new IEs.

In this context, some embodiments herein account for dynamic modification of XR traffic characteristics, e.g., XR periodicity information, in order to fulfill the XR service requirements. Since XR application has a stringent latency requirement, some embodiments herein advantageously enable the dynamic change of periodicity to be reflected in NG-RAN for fast adaptation of resource allocation and UE configuration.

Heretofore, in order to change the XR traffic characteristics (e.g., periodicity), some information would need to be signalled during the setup or the modification of the PDU session procedure from UPF to NG-RAN, which would require running the PDU Session Management procedure over the network interfaces (NG, F1, E1, Xn, Uu). This can be considered as too onerous in terms of signalling, especially for frequent changes, where many interfaces need to be instantiated, do the “hand-shaking signalling” from the Core Network to gNB-CU-UP and then from gNB-CU-UP to gNB-DU for Downlink (DL); and the other way around for Uplink (UL).

Certain aspects of the disclosure and their embodiments may provide solutions to these or other challenges.

Some User Plane (UP) signalling embodiments, for example, include signaling methods for indicating XR application XR traffic characteristics, e.g., XR periodicity information, in a GTP-extension header in order to let NG-RAN be aware of that information or its change for radio resource allocation and early RAN traffic control during downlink (DL) signalling. Some embodiments additionally or alternatively propose to signal the feedback related to XR application traffic characteristics, e.g., in the UP.

Alternatively or additionally, some Control Plane (CP) signalling embodiments include signaling methods for indicating XR application XR traffic characteristics, e.g., periodicity information, in NG-C interface in order to let NG-RAN be aware of that information or its change for radio resource allocation and early RAN traffic control.

Some embodiments herein allow the introduction and modification of the XR traffic characteristics, e.g., periodicity in-band for both DL and UL.

In particular, over UP, some embodiments allow modification of the XR traffic characteristics on the DL, by adding the information in GTP-U Extension Header. Since the GTP-U Extension Header conveys the PDU session user plane protocol data, the XR Traffic information may be added in the DL PDU SESSION INFORMATION frame in, among others, NG-U and Xn-U, F1-U. Alternatively or additionally, some embodiments allow modification of the XR traffic characteristics on the UL, by signaling the updated periodicity information over e.g., RRC message(s). Alternatively, the UL is coming from the core network (CN) which obtains the information from the application layer.

Alternatively or additionally, over CP, some embodiments allow modification of the XR traffic characteristics by adding the information in a new NG-AP, e.g., a class 2 procedure, where the CN signals to the NG-RAN the XR traffic characteristics to consider for scheduling.

Certain embodiments may provide one or more of the following technical advantage(s). By including information of XR traffic periodicity and its dynamic change due to application adaptation in new GTP extension header information, some embodiments advantageously ensure NG-RAN is aware of that information for use in scheduling and save on signalling by avoiding the heavy PDU session management procedures when frequent updates are needed. Alternatively or additionally, some embodiments advantageously allow rate adaptation when the CN informs of change of periodicity or frames per second.

### XR Traffic Periodicity Information

XR traffic is diverse and may be a compound of multiple flows such as, for example, video, audio, or application control. In one embodiment, each of the XR Traffic flows could have different periodicities and a periodicity in a XR Traffic flow could change independently from the periodicity of the other flows since the XR application may change its configuration caused by encoding rate control and/or adaptive display configuration. Thus, according to some embodiments, the UE may report the periodicities for each of the flows, or only for those flows which periodicity has changed.

Some embodiments herein use one or more possible ways to convey the periodicity information per NG-C, or GTU-U header. The XR periodicity information can be: (i) the periodicity value itself; (ii) or a change from the previous periodicity (linear addition or subtraction or multiplication or division); (iii) or an index referring to a value from a predetermined periodicity set/table.

The periodicity information may be skipped if there is no change or can be always included in every NG-C message or GTU-header.

In the presence of the periodicity information in the NG-C message or GTP-U Ext header, it will trigger the endorsement of the periodicity information at the receiver. In the case of signalling a changed value from the previous periodicity (linear addition or subtraction or multiplication or division), it means the update of periodicity information compared to previous received periodicity information.

It is also possible that the timing of periodicity information to be applied can be included to allow a receiver to prepare the periodicity change in advance. Such early indication will reduce potential short-term misconfiguration of radio resource which would cause a latency spike in the RAN. The timing information can be defined in terms of a number of slots from when the PDU is received or from when the PDU is generated. If no timing information is included, a receiver applies the new periodicity information after X time units since a PDU with the new periodicity information is received. X time units can also allow immediate use of the new information.

Consider now detailed embodiments on how to signal the XR traffic information with the periodicity information, as described in above embodiments, in both CP and UP signalling to NG-RAN.

### CP Signalling Solution

In one CP signaling embodiment, a new procedure, e.g., class 2 “XR Traffic Parameters Control” message is defined to introduce or update the XR Traffic Characteristic (e.g., periodicity information as defined herein) from CN to NG-RAN Node.

In another CP signaling embodiment, an existing NG-AP procedure is used to convey the XR traffic information to introduce or update the XR periodicity information as from CN to NG-RAN.

In one CP signaling embodiment, the NG-AP procedure includes the XR traffic Flow identifier, the XR periodicity, and a mapping of the XR Traffic flow to the XR QoS flow.

In another CP signaling embodiment, the NG-RAN can inform of the endorsed XR traffic characteristic over a class 2 “XR Traffic Parameters Feedback” message. Alternatively, the interaction between CN and NG-RAN over NG-C can be achieved via a class 1 request/response procedure.

### UP Solution

It shall be noted that GTP-Uv1 as specified in TS 29.281 V17.1.0 is used on the N3/NG-U interface between the UPF and the NG-RAN/CU-UP as well as on the F1-U interface between the CU-UP and the DU and the CU-UPs configured with different NG-RAN/gNBs where Xn-U is established. However, the details on the content of the GTP-U headers are specified in TS 38.415 V16.6.0 for the NG-U/N3 and the TS 38.425 V16.3.0 is applicable for the F1-U and XN-U interface.

The detailed description is based on adding one or more fields on the GTP header which provides TSC periodicity information.

### DL XR Traffic Flow Information Indication

Some embodiments herein convey the DL XR traffic flow information in a DL PDU SESSION INFORMATION as shown below in Table 1, e.g., as otherwise consistent with TS 38.415 v16.6.0, as one example without loss of generality.

TABLE 1
DL PDU SESSION INFORMATION (PDU Type 0) Format

| Bits | | | | | | | | Number of |
|---|---|---|---|---|---|---|---|---|
| 7 | 6 | 5 | 4 | 3 | 2 | 1 | 0 | Octets |

| | | | | |
|---|---|---|---|---|
| PDU Type (=0) | QMP | SNP | Spare | 1 |

| | | | |
|---|---|---|---|
| PPP | RQI | QoS Flow Identifier | 1 |

| PPI | XR | Spare | 0 or 1 |
|---|---|---|---|
| | Traffic | | |
| | flow | | |

| | |
|---|---|
| DL Sending Time Stamp | 0 or 8 |
| DL QFI Sequence Number | 0 or 3 |
| XR Traffic Flow Identifier | |
| XR Traffic Periodicity information | |
| Padding | 0-3 |

In some embodiments, this DL PDU SESSION INFORMATION frame format is defined to allow the NG-RAN to receive some control information elements which are associated with the transfer of a packet over the interface. Some embodiments herein introduce the below fields for conveying XR traffic information.

### XR Traffic Flow

Description: This field indicates the presence of XR Traffic Flow Information: XR Traffic Flow Identifier and XR Traffic Periodicity Information.
Value range: {0=the XR traffic information is not present; 1=the XR traffic information is present}.
Field length: 1 bit.

### XR Traffic Flow Identifier

Description: When present this parameter indicates the XR Traffic Flow Identifier of the XR flow to which the transferred XR packet belongs.
Value range: {0 . . . 2⁸−1}.
Field length: 8 bits.

### XR Traffic Periodicity Information

Description: This field indicates the Periodicity of the XR traffic flow for the XR application as defined in TS 23.501. Periodicity expressed in units of 1 us.
Value range: {0 . . . 2³²−1}.
Field length: 4 octets.

Other embodiments herein convey the DL XR traffic flow information in a DL USER DATA, which is applicable for the F1-U and the Xn-U, X2-U (EN-DC) interface. One example of DL USER DATA according to some embodiments is as shown below in Table 2, e.g., as otherwise consistent with TS 38.425 v16.3.0, with the XR Traffic Periodicity Information field as described above:

TABLE 2
DL USER DATA (PDU Type 0) Format

| Bits | | | | | | | | Number of |
|---|---|---|---|---|---|---|---|---|
| 7 | 6 | 5 | 4 | 3 | 2 | 1 | 0 | Octets |

| PDU Type (=0) | | Spare | DL | DL Flush | Report polling | 1 |
|---|---|---|---|---|---|---|
| | | | Discard | | | |
| | | | Blocks | | | |
| Spare | Request | Report | User | Assistance | Retransmission | 1 |
| | OutofSeq | Delivered | data | Info. | flag | |
| | Report | | existence | Report | | |
| | | | flag | Polling | | |
| | | | | Flag | | |

| | |
|---|---|
| NR-U Sequence Number | 3 |
| DL discard NR PDCP PDU SN | 0 or 3 |
| DL discard Number of blocks | 0 or 1 |
| DL discard NR PDCP PDU SN start (first block) | 0 or 3 |
| Discarded Block size (first block) | 0 or 1 |
| . . . | |
| DL discard NR PDCP PDU SN start (last block) | 0 or 3 |
| Discarded Block size (last block) | 0 or 1 |
| DL report NR PDCP PDU SN | 0 or 3 |
| Padding | 0-3 |
| XR Traffic Periodicity information | 0 or 4 |

Still other embodiments herein convey the DL XR traffic flow information in a DL DATA DELIVERY STATUS as shown below in Table 3, with the XR Traffic Periodicity Information field as described above:

TABLE 3
DL DATA DELIVERY STATUS (PDU Type 1) Format

| Bits | | | | | | | | Number of |
|---|---|---|---|---|---|---|---|---|
| 7 | 6 | 5 | 4 | 3 | 2 | 1 | 0 | Octets |

| PDU Type (=1) | | Highest | Highest | Final Frame | Lost | 1 |
|---|---|---|---|---|---|---|
| | | Transmitted | Delivered NR | Ind. | Packet | |
| | | NR PDCP | PDCP SN Ind | | Report | |
| | | SN Ind | | | | |
| Spare | Delivered | Data rate | Retransmitted | Delivered | Cause | 1 |
| | NR | Ind. | NR PDCP SN | Retransmitted | Report | |
| | PDCP | | Ind | NR PDCP SN | | |
| | SN | | | Ind | | |
| | Range | | | | | |
| | Ind | | | | | |

| Desired buffer size for the data radio bearer | 4 |
|---|---|
| Desired Data Rate | 0 or 4 |
| Number of lost NR-U Sequence Number ranges reported | 0 or 1 |
| Start of lost NR-U Sequence Number range | 0 or (6* |
| End of lost NR-U Sequence Number range | Number of |
| | reported |
| | lost NR-U |
| | SN ranges) |
| Highest successfully delivered NR PDCP Sequence Number | 0 or 3 |
| Highest transmitted NR PDCP Sequence Number | 0 or 3 |
| Cause Value | 0 or 1 |
| Successfully delivered retransmitted NR PDCP Sequence Number | 0 or 3 |
| Retransmitted NR PDCP Sequence Number | 0 or 3 |
| Number of successfully delivered out of sequence PDCP Sequence Number | 0 or 1 |
| range | |
| Start of successfully delivered out of sequence PDCP Sequence Number range | 0 or (6* |
| End of successfully delivered out of sequence PDCP Sequence Number range | Number of |
| | successfully |
| | delivered |
| | out of |
| | sequence |
| | PDCP |
| | Sequence |
| | Number |
| | range) |
| Padding | 0-3 |
| XR traffic Periodicity information | 0 or 4 |

### UL Periodicity Indication

XR traffic is diverse and may be a compound of multiple flows such as, for example, video, audio, or application control. Each of these flows could have different periodicities and a periodicity in a flow could change independently from the periodicity of the other flows. Thus, the UE may report the periodicities for each of the flows, or only for those flows which periodicity has changed. Regarding the UL signalling, the updated periodicity information can be signalled over RRC message(s), such as the UE Assistance message defined in TS 38.331 v16.7.0. The signaling structure would be a similar type of signaling as shown in the DL above, i.e., the periodicity would be indicated per XR traffic flow. The periodicity could be defined as an index from a set of defined periodicities. For example, for video, the number of frames per second and, therefore, the periodicities are well established. Thus, a list of frames per second or periodicities could be defined, and the UE would indicate the index to the list of values. This type of signaling reduces the number of bits to indicate the information. Alternatively, the UE could explicitly indicate the frames per seconds or periodicity. This allows much more flexibility; however, it will require more bits to provide this indication. In another way, the change from previous periodicity value can be signalled so that a receiver simply increases or decreases the periodicity by the amount of the indicated change.

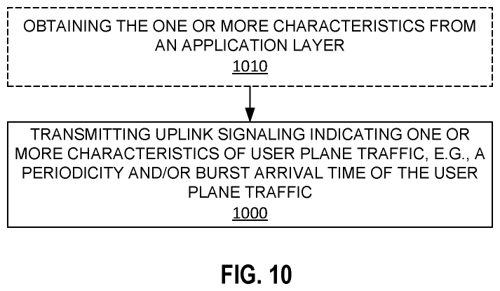

In view of the modifications and variations herein, FIG. 10 shows a method performed by a communication device 12 in a communication network 10. The method comprises transmitting uplink signaling indicating one or more characteristics of user plane traffic 14 (Block 1000).

In some embodiments, the uplink signaling is transmitted in a radio resource control, RRC, message. In one or more of these embodiments, the RRC message is a UE Assistance message.

In some embodiments, the one or more characteristics include a periodicity of the user plane traffic 14.

In some embodiments, the one or more characteristics include a burst arrival time of the user plane traffic 14.

In some embodiments, the one or more characteristics include one or more characteristics at an application layer.

In some embodiments, the method further comprises obtaining the one or more characteristics from an application layer (Block 1010).

In some embodiments, the one or more characteristics are one or more time-sensitive communication, TSC, characteristics.

In some embodiments, the uplink signaling indicates one or more characteristics of user plane traffic 14 for each of one or more flows. In one or more of these embodiments, the one or more flows are one or more XR traffic flows.

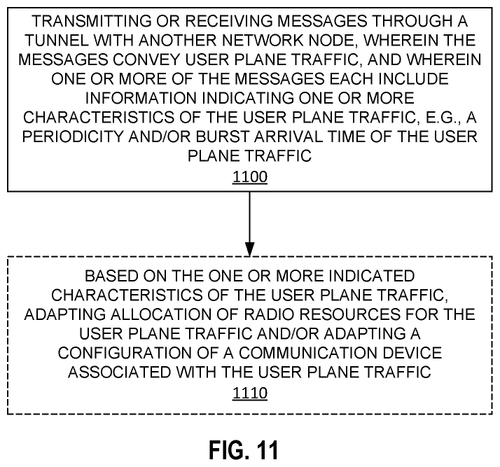

FIG. 11 depicts a method performed by a network node 10-1, 10-2 in a communication network 10. The method comprises transmitting or receiving messages M through a tunnel T with another network node 10-2, 10-1. In some embodiments, the messages M convey user plane traffic 14 (Block 1100). In some embodiments, one or more of the messages M each include information 16 indicating one or more characteristics of the user plane traffic 14.

In some embodiments, the one or more characteristics include a periodicity of the user plane traffic 14.

In some embodiments, the one or more characteristics include a burst arrival time of the user plane traffic 14.

In some embodiments, the one or more characteristics are one or more time-sensitive communication, TSC, characteristics.

In some embodiments, the messages M convey user plane traffic 14 for one or more flows. In some embodiments, information 16 included in a message M conveying user plane traffic 14 for a flow indicates one or more characteristics of the user plane traffic 14 for that flow. In one or more of these embodiments, the user plane traffic 14 is extended Reality, XR, traffic, wherein the one or more flows are one or more XR traffic flows.

In some embodiments, the tunnel T is a GTP-U tunnel. In one or more of these embodiments, the one or more messages M each include the information 16 indicating one or more characteristics of the user plane traffic 14 in a GTP-U extension header.

In some embodiments, the one or more messages M each include the information 16 indicating one or more characteristics of the user plane traffic 14 in a DL PDU SESSION INFORMATION frame.

In some embodiments, the one or more messages M each include the information 16 indicating one or more characteristics of the user plane traffic 14 in a DL USER DATA frame.

In some embodiments, the one or more messages M each include the information 16 indicating one or more characteristics of the user plane traffic M in a DL DATA DELIVERY STATUS frame.

In some embodiments, said transmitting or receiving comprises transmitting the messages M. In one or more of these embodiments, the network node 10-1, 10-2 is a core network node, and the another network node 10-1, 10-2 is a radio network node. In one or more of these embodiments, the core network node implements a User Plane Function, UPF. In one or more of these embodiments, the network node 10-1, 10-2 comprises a central unit of a radio network node and the another network node 10-1, 10-2 comprises a distributed unit of the radio network node.

In some embodiments, said transmitting or receiving comprises receiving the messages M. In one or more of these embodiments, the another network node 10-1, 10-2 is a core network node, and the network node 10-1, 10-2 is a radio network node. In one or more of these embodiments, the core network node implements a User Plane Function, UPF. In one or more of these embodiments, the another network node 10-1, 10-2 comprises a central unit of a radio network node and the network node 10-1, 10-2 comprises a distributed unit of the radio network node. In one or more of these embodiments, the method further comprises, based on the one or more indicated characteristics of the user plane traffic 14, adapting allocation of radio resources for the user plane traffic 14 and/or adapting a configuration of a communication device 12 associated with the user plane traffic 14 (Block 1110).

In some embodiments, the one or more messages M each further include a quality of service, QoS, flow identifier identifying a QoS flow to which the message M or the user plane traffic 14 conveyed by the message M belongs.

In some embodiments, the one or more messages M each further include other information indicating one or more requirements for conveying the user plane traffic 14. In one or more of these embodiments, the messages M convey user plane traffic 14 for one or more QoS flows. In some embodiments, other information included in a message M conveying user plane traffic 14 for a QoS flow indicates the one or more requirements for conveying the user plane traffic 14 for that QoS flow. In one or more of these embodiments, the other information included in a message M conveying user plane traffic 14 for a QoS flow indicates the one or more requirements for conveying the user plane traffic 14 for that QoS flow by indicating an identifier of that QoS flow.

In some embodiments, the messages M are downlink messages.

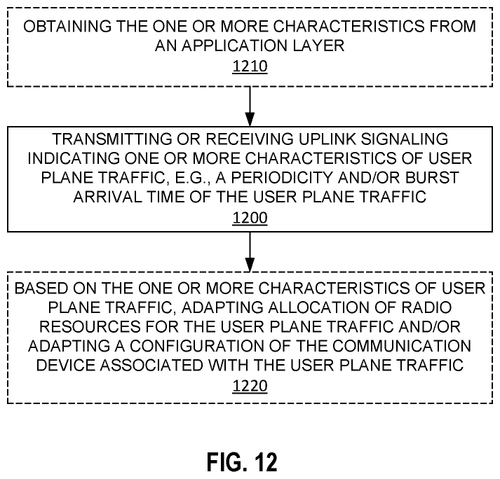

FIG. 12 shows a method performed by a network node 10-1, 10-2 in a communication network 10. The method comprises transmitting or receiving uplink signaling indicating one or more characteristics of user plane traffic 14 (Block 1200).

In some embodiments, the one or more characteristics include a periodicity of the user plane traffic 14.

In some embodiments, the one or more characteristics include a burst arrival time of the user plane traffic 14.

In some embodiments, said transmitting or receiving comprises receiving the uplink signaling. In one or more of these embodiments, the uplink signaling is received from a communication device 12.

In some embodiments, the uplink signaling is received in a radio resource control, RRC, message. In one or more of these embodiments, the RRC message is a UE Assistance message.

In some embodiments, said transmitting or receiving comprises transmitting the uplink signaling. In one or more of these embodiments, the uplink signaling is transmitted to another network node 10-1, 10-2.

In some embodiments, the one or more characteristics include one or more characteristics at an application layer.

In some embodiments, the method further comprises obtaining the one or more characteristics from an application layer (Block 1210).

In some embodiments, the one or more characteristics are one or more time-sensitive communication, TSC, characteristics.

In some embodiments, the uplink signaling indicates one or more characteristics of user plane traffic 14 for each of one or more flows. In one or more of these embodiments, the one or more flows are one or more XR traffic flows.

In some embodiments, the method also comprises, based on the one or more characteristics of user plane traffic 14, adapting allocation of radio resources for the user plane traffic 14 and/or adapting a configuration of the communication device 12 associated with the user plane traffic 14 (Block 1220).

Embodiments herein also include corresponding apparatuses. Embodiments herein for instance include a wireless communication device configured to perform any of the steps of any of the embodiments described above for the wireless device.

Embodiments also include a communication device 12 comprising processing circuitry and power supply circuitry. The processing circuitry is configured to perform any of the steps of any of the embodiments described above for the communication device 12. The power supply circuitry is configured to supply power to the communication device 12.

Embodiments further include a communication device 12 comprising processing circuitry. The processing circuitry is configured to perform any of the steps of any of the embodiments described above for the communication device 12. In some embodiments, the communication device 12 further comprises communication circuitry.

Embodiments further include a communication device 12 comprising processing circuitry and memory. The memory contains instructions executable by the processing circuitry whereby the communication device 12 is configured to perform any of the steps of any of the embodiments described above for the communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 10-1, 10-2 configured to perform any of the steps of any of the embodiments described above for the network node 10-1, 10-2.

Embodiments also include a network node 10-1, 10-2 comprising processing circuitry and power supply circuitry. The processing circuitry is configured to perform any of the steps of any of the embodiments described above for the network node 10-1, 10-2. The power supply circuitry is configured to supply power to the network node 10-1, 10-2.

Embodiments further include a network node 10-1, 10-2 comprising processing circuitry. The processing circuitry is configured to perform any of the steps of any of the embodiments described above for the network node 10-1, 10-2. In some embodiments, the network node 10-1, 10-2 further comprises communication circuitry.

Embodiments further include a network node 10-1, 10-2 comprising processing circuitry and memory. The memory contains instructions executable by the processing circuitry whereby the network node 10-1, 10-2 is configured to perform any of the steps of any of the embodiments described above for the network node 10-1, 10-2.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

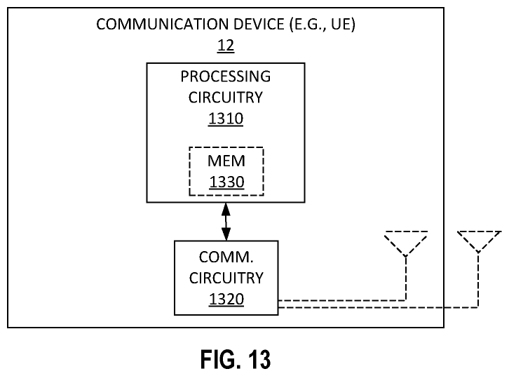

FIG. 13 for example illustrates a communication device 12 as implemented in accordance with one or more embodiments. As shown, the communication device 12 1300 includes processing circuitry 1310 and communication circuitry 1320. The communication circuitry 1320 (e.g., radio circuitry) is configured to transmit and/or receive information to and/or from one or more other nodes, e.g., via any communication technology. Such communication may occur via one or more antennas that are either internal or external to the wireless communication device 1300. The processing circuitry 1310 is configured to perform processing described above, e.g., in FIG. 10, such as by executing instructions stored in memory 1330. The processing circuitry 1310 in this regard may implement certain functional means, units, or modules.

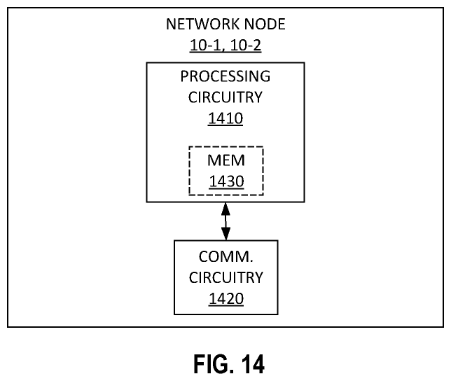

FIG. 14 illustrates a network node 10-1, 10-2 as implemented in accordance with one or more embodiments. As shown, the network node 10-1, 10-2 includes processing circuitry 1410 and communication circuitry 1420. The communication circuitry 1420 is configured to transmit and/or receive information to and/or from one or more other nodes, e.g., via any communication technology. The processing circuitry 1410 is configured to perform processing described above, e.g., in FIGS. 11 and/or 12, such as by executing instructions stored in memory 1430. The processing circuitry 1410 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

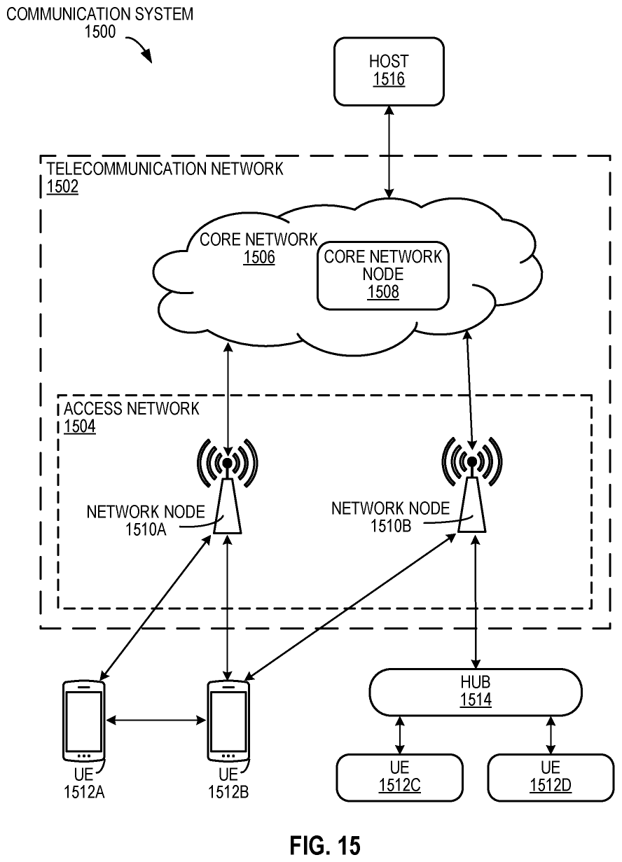

FIG. 15 shows an example of a communication system 1500 in accordance with some embodiments.

In the example, the communication system 1500 includes a telecommunication network 1502 that includes an access network 1504, such as a radio access network (RAN), and a core network 1506, which includes one or more core network nodes 1508. The access network 1504 includes one or more access network nodes, such as network nodes 1510a and 1510b (one or more of which may be generally referred to as network nodes 1510), or any other similar 3rd Generation Partnership Project (3GPP) access node or non-3GPP access point. The network nodes 1510 facilitate direct or indirect connection of user equipment (UE), such as by connecting UEs 1512a, 1512b, 1512c, and 1512d (one or more of which may be generally referred to as UEs 1512) to the core network 1506 over one or more wireless connections. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1500 may include any number of wired or wireless networks, network nodes, UEs, and/or any other components or systems that may facilitate or participate in the communication of data and/or signals whether via wired or wireless connections. The communication system 1500 may include and/or interface with any type of communication, telecommunication, data, cellular, radio network, and/or other similar type of system.

The UEs 1512 may be any of a wide variety of communication devices, including wireless devices arranged, configured, and/or operable to communicate wirelessly with the network nodes 1510 and other communication devices. Similarly, the network nodes 1510 are arranged, capable, configured, and/or operable to communicate directly or indirectly with the UEs 1512 and/or with other network nodes or equipment in the telecommunication network 1502 to enable and/or provide network access, such as wireless network access, and/or to perform other functions, such as administration in the telecommunication network 1502.

In the depicted example, the core network 1506 connects the network nodes 1510 to one or more hosts, such as host 1516. These connections may be direct or indirect via one or more intermediary networks or devices. In other examples, network nodes may be directly coupled to hosts. The core network 1506 includes one more core network nodes (e.g., core network node 1508) that are structured with hardware and software components. Features of these components may be substantially similar to those described with respect to the UEs, network nodes, and/or hosts, such that the descriptions thereof are generally applicable to the corresponding components of the core network node 1508. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1516 may be under the ownership or control of a service provider other than an operator or provider of the access network 1504 and/or the telecommunication network 1502, and may be operated by the service provider or on behalf of the service provider. The host 1516 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1500 of FIG. 15 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1502 is a cellular network that implements 3GPP standardized features. Accordingly, the telecommunications network 1502 may support network slicing to provide different logical networks to different devices that are connected to the telecommunication network 1502. For example, the telecommunications network 1502 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1512 are configured to transmit and/or receive information without direct human interaction. For instance, a UE may be designed to transmit information to the access network 1504 on a predetermined schedule, when triggered by an internal or external event, or in response to requests from the access network 1504. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1514 communicates with the access network 1504 to facilitate indirect communication between one or more UEs (e.g., UE 1512c and/or 1512d) and network nodes (e.g., network node 1510b). In some examples, the hub 1514 may be a controller, router, content source and analytics, or any of the other communication devices described herein regarding UEs. For example, the hub 1514 may be a broadband router enabling access to the core network 1506 for the UEs. As another example, the hub 1514 may be a controller that sends commands or instructions to one or more actuators in the UEs. Commands or instructions may be received from the UEs, network nodes 1510, or by executable code, script, process, or other instructions in the hub 1514. As another example, the hub 1514 may be a data collector that acts as temporary storage for UE data and, in some embodiments, may perform analysis or other processing of the data. As another example, the hub 1514 may be a content source. For example, for a UE that is a VR headset, display, loudspeaker or other media delivery device, the hub 1514 may retrieve VR assets, video, audio, or other media or data related to sensory information via a network node, which the hub 1514 then provides to the UE either directly, after performing local processing, and/or after adding additional local content. In still another example, the hub 1514 acts as a proxy server or orchestrator for the UEs, in particular in if one or more of the UEs are low energy IoT devices.

The hub 1514 may have a constant/persistent or intermittent connection to the network node 1510b. The hub 1514 may also allow for a different communication scheme and/or schedule between the hub 1514 and UEs (e.g., UE 1512c and/or 1512d), and between the hub 1514 and the core network 1506. In other examples, the hub 1514 is connected to the core network 1506 and/or one or more UEs via a wired connection. Moreover, the hub 1514 may be configured to connect to an M2M service provider over the access network 1504 and/or to another UE over a direct connection. In some scenarios, UEs may establish a wireless connection with the network nodes 1510 while still connected via the hub 1514 via a wired or wireless connection. In some embodiments, the hub 1514 may be a dedicated hub—that is, a hub whose primary function is to route communications to/from the UEs from/to the network node 1510b. In other embodiments, the hub 1514 may be a non-dedicated hub—that is, a device which is capable of operating to route communications between the UEs and network node 1510b, but which is additionally capable of operating as a communication start and/or end point for certain data channels.

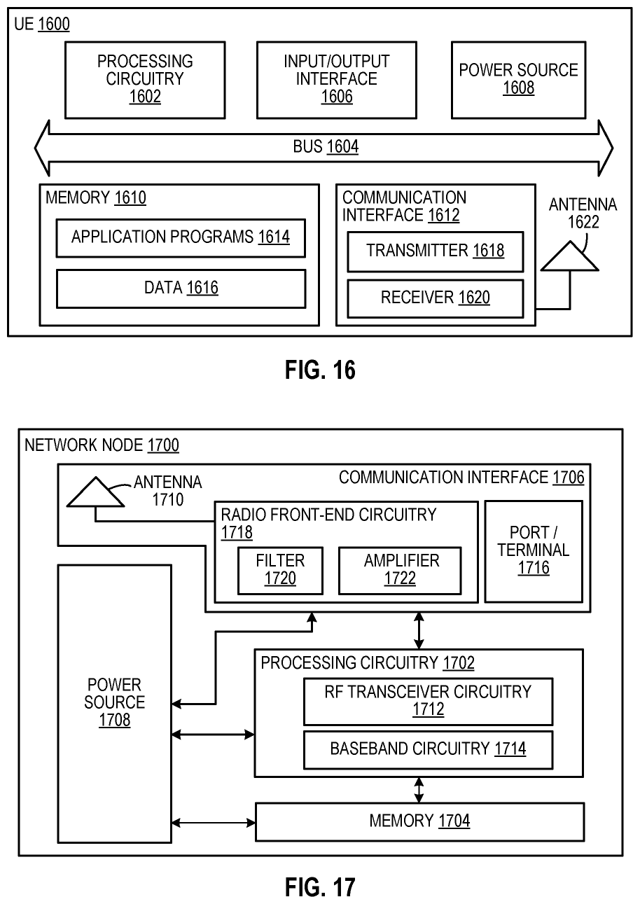

FIG. 16 shows a UE 1600 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1600 includes processing circuitry 1602 that is operatively coupled via a bus 1604 to an input/output interface 1606, a power source 1608, a memory 1610, a communication interface 1612, and/or any other component, or any combination thereof. Certain UEs may utilize all or a subset of the components shown in FIG. 16. The level of integration between the components may vary from one UE to another UE. Further, certain UEs may contain multiple instances of a component, such as multiple processors, memories, transceivers, transmitters, receivers, etc.

The processing circuitry 1602 is configured to process instructions and data and may be configured to implement any sequential state machine operative to execute instructions stored as machine-readable computer programs in the memory 1610. The processing circuitry 1602 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1602 may include multiple central processing units (CPUs).

In the example, the input/output interface 1606 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1608 is structured as a battery or battery pack. Other types of power sources, such as an external power source (e.g., an electricity outlet), photovoltaic device, or power cell, may be used. The power source 1608 may further include power circuitry for delivering power from the power source 1608 itself, and/or an external power source, to the various parts of the UE 1600 via input circuitry or an interface such as an electrical power cable. Delivering power may be, for example, for charging of the power source 1608. Power circuitry may perform any formatting, converting, or other modification to the power from the power source 1608 to make the power suitable for the respective components of the UE 1600 to which power is supplied.

The memory 1610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1610 includes one or more application programs 1614, such as an operating system, web browser application, a widget, gadget engine, or other application, and corresponding data 1616. The memory 1610 may store, for use by the UE 1600, any of a variety of various operating systems or combinations of operating systems.

The memory 1610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1610 may allow the UE 1600 to access instructions, application programs and the like, stored on transitory or non-transitory memory media, to off-load data, or to upload data. An article of manufacture, such as one utilizing a communication system may be tangibly embodied as or in the memory 1610, which may be or comprise a device-readable storage medium.

The processing circuitry 1602 may be configured to communicate with an access network or other network using the communication interface 1612. The communication interface 1612 may comprise one or more communication subsystems and may include or be communicatively coupled to an antenna 1622. The communication interface 1612 may include one or more transceivers used to communicate, such as by communicating with one or more remote transceivers of another device capable of wireless communication (e.g., another UE or a network node in an access network). Each transceiver may include a transmitter 1618 and/or a receiver 1620 appropriate to provide network communications (e.g., optical, electrical, frequency allocations, and so forth). Moreover, the transmitter 1618 and receiver 1620 may be coupled to one or more antennas (e.g., antenna 1622) and may share circuit components, software or firmware, or alternatively be implemented separately.

In the illustrated embodiment, communication functions of the communication interface 1612 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1612, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1600 shown in FIG. 16.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 17 shows a network node 1700 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1700 includes a processing circuitry 1702, a memory 1704, a communication interface 1706, and a power source 1708. The network node 1700 may be composed of multiple physically separate components (e.g., a NodeB component and a RNC component, or a BTS component and a BSC component, etc.), which may each have their own respective components. In certain scenarios in which the network node 1700 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1700 may be configured to support multiple radio access technologies (RATs). In such embodiments, some components may be duplicated (e.g., separate memory 1704 for different RATs) and some components may be reused (e.g., a same antenna 1710 may be shared by different RATs). The network node 1700 may also include multiple sets of the various illustrated components for different wireless technologies integrated into network node 1700, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1700.

The processing circuitry 1702 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1700 components, such as the memory 1704, to provide network node 1700 functionality.

In some embodiments, the processing circuitry 1702 includes a system on a chip (SOC). In some embodiments, the processing circuitry 1702 includes one or more of radio frequency (RF) transceiver circuitry 1712 and baseband processing circuitry 1714. In some embodiments, the radio frequency (RF) transceiver circuitry 1712 and the baseband processing circuitry 1714 may be on separate chips (or sets of chips), boards, or units, such as radio units and digital units. In alternative embodiments, part or all of RF transceiver circuitry 1712 and baseband processing circuitry 1714 may be on the same chip or set of chips, boards, or units.

The memory 1704 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1702. The memory 1704 may store any suitable instructions, data, or information, including a computer program, software, an application including one or more of logic, rules, code, tables, and/or other instructions capable of being executed by the processing circuitry 1702 and utilized by the network node 1700. The memory 1704 may be used to store any calculations made by the processing circuitry 1702 and/or any data received via the communication interface 1706. In some embodiments, the processing circuitry 1702 and memory 1704 is integrated.

The communication interface 1706 is used in wired or wireless communication of signaling and/or data between a network node, access network, and/or UE. As illustrated, the communication interface 1706 comprises port(s)/terminal(s) 1716 to send and receive data, for example to and from a network over a wired connection. The communication interface 1706 also includes radio front-end circuitry 1718 that may be coupled to, or in certain embodiments a part of, the antenna 1710. Radio front-end circuitry 1718 comprises filters 1720 and amplifiers 1722. The radio front-end circuitry 1718 may be connected to an antenna 1710 and processing circuitry 1702. The radio front-end circuitry may be configured to condition signals communicated between antenna 1710 and processing circuitry 1702. The radio front-end circuitry 1718 may receive digital data that is to be sent out to other network nodes or UEs via a wireless connection. The radio front-end circuitry 1718 may convert the digital data into a radio signal having the appropriate channel and bandwidth parameters using a combination of filters 1720 and/or amplifiers 1722. The radio signal may then be transmitted via the antenna 1710. Similarly, when receiving data, the antenna 1710 may collect radio signals which are then converted into digital data by the radio front-end circuitry 1718. The digital data may be passed to the processing circuitry 1702. In other embodiments, the communication interface may comprise different components and/or different combinations of components.

In certain alternative embodiments, the network node 1700 does not include separate radio front-end circuitry 1718, instead, the processing circuitry 1702 includes radio front-end circuitry and is connected to the antenna 1710. Similarly, in some embodiments, all or some of the RF transceiver circuitry 1712 is part of the communication interface 1706. In still other embodiments, the communication interface 1706 includes one or more ports or terminals 1716, the radio front-end circuitry 1718, and the RF transceiver circuitry 1712, as part of a radio unit (not shown), and the communication interface 1706 communicates with the baseband processing circuitry 1714, which is part of a digital unit (not shown).

The antenna 1710 may include one or more antennas, or antenna arrays, configured to send and/or receive wireless signals. The antenna 1710 may be coupled to the radio front-end circuitry 1718 and may be any type of antenna capable of transmitting and receiving data and/or signals wirelessly. In certain embodiments, the antenna 1710 is separate from the network node 1700 and connectable to the network node 1700 through an interface or port.

The antenna 1710, communication interface 1706, and/or the processing circuitry 1702 may be configured to perform any receiving operations and/or certain obtaining operations described herein as being performed by the network node. Any information, data and/or signals may be received from a UE, another network node and/or any other network equipment. Similarly, the antenna 1710, the communication interface 1706, and/or the processing circuitry 1702 may be configured to perform any transmitting operations described herein as being performed by the network node. Any information, data and/or signals may be transmitted to a UE, another network node and/or any other network equipment.

The power source 1708 provides power to the various components of network node 1700 in a form suitable for the respective components (e.g., at a voltage and current level needed for each respective component). The power source 1708 may further comprise, or be coupled to, power management circuitry to supply the components of the network node 1700 with power for performing the functionality described herein. For example, the network node 1700 may be connectable to an external power source (e.g., the power grid, an electricity outlet) via an input circuitry or interface such as an electrical cable, whereby the external power source supplies power to power circuitry of the power source 1708. As a further example, the power source 1708 may comprise a source of power in the form of a battery or battery pack which is connected to, or integrated in, power circuitry. The battery may provide backup power should the external power source fail.

Embodiments of the network node 1700 may include additional components beyond those shown in FIG. 17 for providing certain aspects of the network node's functionality, including any of the functionality described herein and/or any functionality necessary to support the subject matter described herein. For example, the network node 1700 may include user interface equipment to allow input of information into the network node 1700 and to allow output of information from the network node 1700. This may allow a user to perform diagnostic, maintenance, repair, and other administrative functions for the network node 1700.

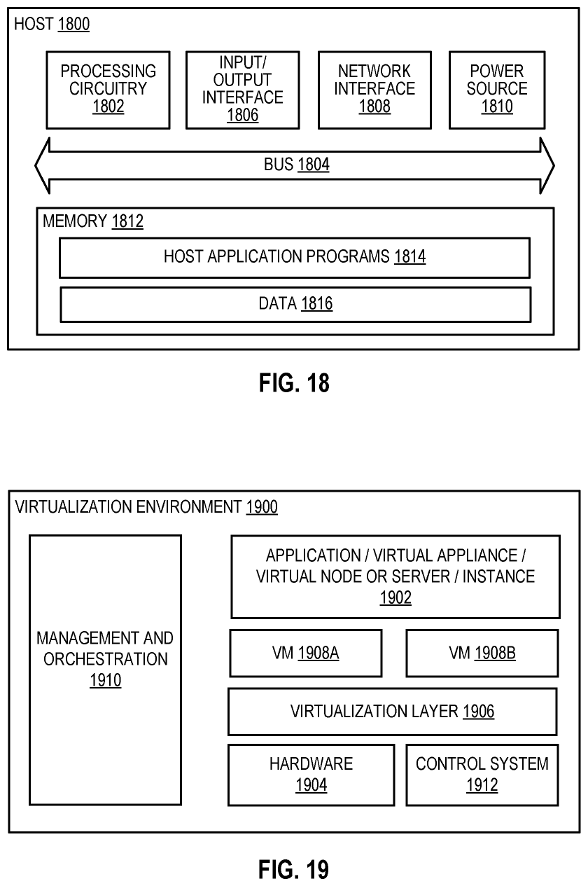

FIG. 18 is a block diagram of a host 1800, which may be an embodiment of the host 1516 of FIG. 15, in accordance with various aspects described herein. As used herein, the host 1800 may be or comprise various combinations hardware and/or software, including a standalone server, a blade server, a cloud-implemented server, a distributed server, a virtual machine, container, or processing resources in a server farm. The host 1800 may provide one or more services to one or more UEs.

The host 1800 includes processing circuitry 1802 that is operatively coupled via a bus 1804 to an input/output interface 1806, a network interface 1808, a power source 1810, and a memory 1812. Other components may be included in other embodiments. Features of these components may be substantially similar to those described with respect to the devices of previous figures, such as FIGS. 16 and 17, such that the descriptions thereof are generally applicable to the corresponding components of host 1800.

The memory 1812 may include one or more computer programs including one or more host application programs 1814 and data 1816, which may include user data, e.g., data generated by a UE for the host 1800 or data generated by the host 1800 for a UE. Embodiments of the host 1800 may utilize only a subset or all of the components shown. The host application programs 1814 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1814 may also provide for user authentication and licensing checks and may periodically report health, routes, and content availability to a central node, such as a device in or on the edge of a core network. Accordingly, the host 1800 may select and/or indicate a different host for over-the-top services for a UE. The host application programs 1814 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 19 is a block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1900 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1902 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1904 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1906 (also referred to as hypervisors or virtual machine monitors (VMMs)), provide VMs 1908a and 1908b (one or more of which may be generally referred to as VMs 1908), and/or perform any of the functions, features and/or benefits described in relation with some embodiments described herein. The virtualization layer 1906 may present a virtual operating platform that appears like networking hardware to the VMs 1908.

The VMs 1908 comprise virtual processing, virtual memory, virtual networking or interface and virtual storage, and may be run by a corresponding virtualization layer 1906. Different embodiments of the instance of a virtual appliance 1902 may be implemented on one or more of VMs 1908, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1908 may be a software implementation of a physical machine that runs programs as if they were executing on a physical, non-virtualized machine. Each of the VMs 1908, and that part of hardware 1904 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1908 on top of the hardware 1904 and corresponds to the application 1902.

Hardware 1904 may be implemented in a standalone network node with generic or specific components. Hardware 1904 may implement some functions via virtualization. Alternatively, hardware 1904 may be part of a larger cluster of hardware (e.g. such as in a data center or CPE) where many hardware nodes work together and are managed via management and orchestration 1910, which, among others, oversees lifecycle management of applications 1902. In some embodiments, hardware 1904 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1912 which may alternatively be used for communication between hardware nodes and radio units.

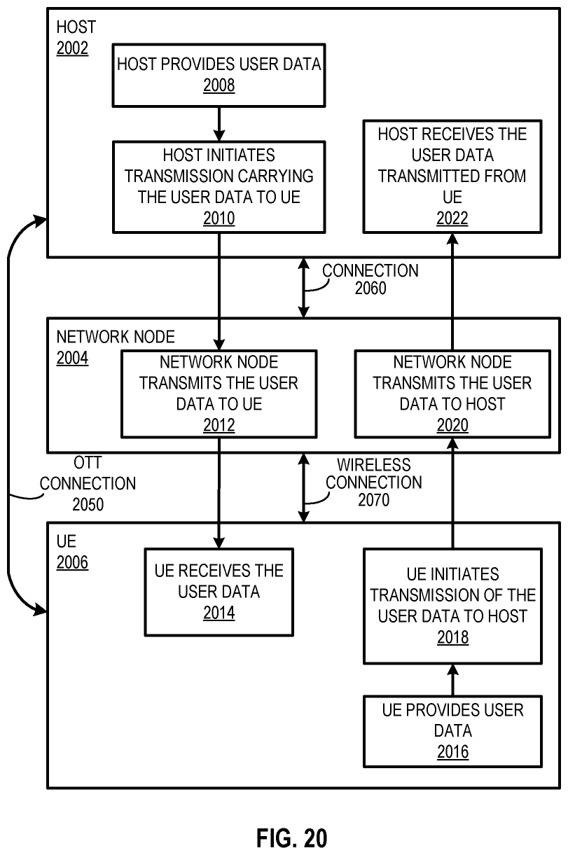

FIG. 20 shows a communication diagram of a host 2002 communicating via a network node 2004 with a UE 2006 over a partially wireless connection in accordance with some embodiments. Example implementations, in accordance with various embodiments, of the UE (such as a UE 1512a of FIG. 15 and/or UE 1600 of FIG. 16), network node (such as network node 1510a of FIG. 15 and/or network node 1700 of FIG. 17), and host (such as host 1516 of FIG. 15 and/or host 1800 of FIG. 18) discussed in the preceding paragraphs will now be described with reference to FIG. 20.

Like host 1800, embodiments of host 2002 include hardware, such as a communication interface, processing circuitry, and memory. The host 2002 also includes software, which is stored in or accessible by the host 2002 and executable by the processing circuitry. The software includes a host application that may be operable to provide a service to a remote user, such as the UE 2006 connecting via an over-the-top (OTT) connection 2050 extending between the UE 2006 and host 2002. In providing the service to the remote user, a host application may provide user data which is transmitted using the OTT connection 2050.

The network node 2004 includes hardware enabling it to communicate with the host 2002 and UE 2006. The connection 2060 may be direct or pass through a core network (like core network 1506 of FIG. 15) and/or one or more other intermediate networks, such as one or more public, private, or hosted networks. For example, an intermediate network may be a backbone network or the Internet.

The UE 2006 includes hardware and software, which is stored in or accessible by UE 2006 and executable by the UE's processing circuitry. The software includes a client application, such as a web browser or operator-specific “app” that may be operable to provide a service to a human or non-human user via UE 2006 with the support of the host 2002. In the host 2002, an executing host application may communicate with the executing client application via the OTT connection 2050 terminating at the UE 2006 and host 2002. In providing the service to the user, the UE's client application may receive request data from the host's host application and provide user data in response to the request data. The OTT connection 2050 may transfer both the request data and the user data. The UE's client application may interact with the user to generate the user data that it provides to the host application through the OTT connection 2050.

The OTT connection 2050 may extend via a connection 2060 between the host 2002 and the network node 2004 and via a wireless connection 2070 between the network node 2004 and the UE 2006 to provide the connection between the host 2002 and the UE 2006. The connection 2060 and wireless connection 2070, over which the OTT connection 2050 may be provided, have been drawn abstractly to illustrate the communication between the host 2002 and the UE 2006 via the network node 2004, without explicit reference to any intermediary devices and the precise routing of messages via these devices.

As an example of transmitting data via the OTT connection 2050, in step 2008, the host 2002 provides user data, which may be performed by executing a host application. In some embodiments, the user data is associated with a particular human user interacting with the UE 2006. In other embodiments, the user data is associated with a UE 2006 that shares data with the host 2002 without explicit human interaction. In step 2010, the host 2002 initiates a transmission carrying the user data towards the UE 2006. The host 2002 may initiate the transmission responsive to a request transmitted by the UE 2006. The request may be caused by human interaction with the UE 2006 or by operation of the client application executing on the UE 2006. The transmission may pass via the network node 2004, in accordance with the teachings of the embodiments described throughout this disclosure. Accordingly, in step 2012, the network node 2004 transmits to the UE 2006 the user data that was carried in the transmission that the host 2002 initiated, in accordance with the teachings of the embodiments described throughout this disclosure. In step 2014, the UE 2006 receives the user data carried in the transmission, which may be performed by a client application executed on the UE 2006 associated with the host application executed by the host 2002.

In some examples, the UE 2006 executes a client application which provides user data to the host 2002. The user data may be provided in reaction or response to the data received from the host 2002. Accordingly, in step 2016, the UE 2006 may provide user data, which may be performed by executing the client application. In providing the user data, the client application may further consider user input received from the user via an input/output interface of the UE 2006. Regardless of the specific manner in which the user data was provided, the UE 2006 initiates, in step 2018, transmission of the user data towards the host 2002 via the network node 2004. In step 2020, in accordance with the teachings of the embodiments described throughout this disclosure, the network node 2004 receives user data from the UE 2006 and initiates transmission of the received user data towards the host 2002. In step 2022, the host 2002 receives the user data carried in the transmission initiated by the UE 2006.

One or more of the various embodiments improve the performance of OTT services provided to the UE 2006 using the OTT connection 2050, in which the wireless connection 2070 forms the last segment.

In an example scenario, factory status information may be collected and analyzed by the host 2002. As another example, the host 2002 may process audio and video data which may have been retrieved from a UE for use in creating maps. As another example, the host 2002 may collect and analyze real-time data to assist in controlling vehicle congestion (e.g., controlling traffic lights). As another example, the host 2002 may store surveillance video uploaded by a UE. As another example, the host 2002 may store or control access to media content such as video, audio, VR or AR which it can broadcast, multicast or unicast to UEs. As other examples, the host 2002 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2050 between the host 2002 and UE 2006, in response to variations in the measurement results. The measurement procedure and/or the network functionality for reconfiguring the OTT connection may be implemented in software and hardware of the host 2002 and/or UE 2006. In some embodiments, sensors (not shown) may be deployed in or in association with other devices through which the OTT connection 2050 passes; the sensors may participate in the measurement procedure by supplying values of the monitored quantities exemplified above, or supplying values of other physical quantities from which software may compute or estimate the monitored quantities. The reconfiguring of the OTT connection 2050 may include message format, retransmission settings, preferred routing etc.; the reconfiguring need not directly alter the operation of the network node 2004. Such procedures and functionalities may be known and practiced in the art. In certain embodiments, measurements may involve proprietary UE signaling that facilitates measurements of throughput, propagation times, latency and the like, by the host 2002. The measurements may be implemented in that software causes messages to be transmitted, in particular empty or ‘dummy’ messages, using the OTT connection 2050 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example embodiments of the techniques and apparatus described herein include, but are not limited to, the following enumerated examples:

### Group A Embodiments

A1. A method performed by a communication device in a communication network, the method comprising:
transmitting uplink signaling indicating one or more characteristics of user plane traffic.
   A2. The method of embodiment A1, wherein the uplink signaling is transmitted in a radio resource control, RRC, message.
   A3. The method of embodiment A2, wherein the RRC message is a UE Assistance message.
   A4. The method of any of embodiments A1-A3, wherein the one or more characteristics include one or more characteristics at an application layer.
   A5. The method of any of embodiments A1-A4, further comprising obtaining the one or more characteristics from an application layer.
   A6. The method of any of embodiments A1-A5, wherein the one or more characteristics include a periodicity of the user plane traffic.
   A7. The method of any of embodiments A1-A6, wherein the one or more characteristics include a burst arrival time of the user plane traffic.
   A8. The method of any of embodiments A1-A7, wherein the one or more characteristics are one or more time-sensitive communication, TSC, characteristics.
   A9. The method of any of embodiments A1-A8, wherein the uplink signaling indicates one or more characteristics of user plane traffic for each of one or more flows.
   A10. The method of embodiment A9, wherein the one or more flows are one or more XR traffic flows.
   AA. The method of any of the previous embodiments, further comprising:
providing user data; and
forwarding the user data to a host computer via the transmission to a base station.

### Group B Embodiments

B1. A method performed by a network node in a communication network, the method comprising:
transmitting or receiving messages through a tunnel with another network node, wherein the messages convey user plane traffic, wherein one or more of the messages each include information indicating one or more characteristics of the user plane traffic.
   B2. The method of embodiment B1, wherein the one or more characteristics include a periodicity of the user plane traffic.
   B3. The method of any of embodiments B1-B2, wherein the one or more characteristics include a burst arrival time of the user plane traffic.
   B4. The method of any of embodiments B1-B3, wherein the one or more characteristics are one or more time-sensitive communication, TSC, characteristics.
   B5. The method of any of embodiments B1-B4, wherein the messages convey user plane traffic for one or more flows, wherein information included in a message conveying user plane traffic for a flow indicates one or more characteristics of the user plane traffic for that flow.
   B6. The method of embodiment B5, wherein the user plane traffic is extended Reality, XR, traffic, wherein the one or more flows are one or more XR traffic flows.
   B7 The method of any of embodiments B1-B6, wherein the tunnel is a GTP-U tunnel.
   B8. The method of embodiment B7, wherein the one or more messages each include the information indicating one or more characteristics of the user plane traffic in a GTP-U extension header.
   B9. The method of any of embodiments B1-B8, wherein the one or more messages each include the information indicating one or more characteristics of the user plane traffic in a DL PDU SESSION INFORMATION frame.
   B10. The method of any of embodiments B1-B8, wherein the one or more messages each include the information indicating one or more characteristics of the user plane traffic in a DL USER DATA frame.
   B11. The method of any of embodiments B1-B8, wherein the one or more messages each include the information indicating one or more characteristics of the user plane traffic in a DL DATA DELIVERY STATUS frame.
   B12. The method of any of embodiments B1-B11, wherein said transmitting or receiving comprises transmitting the messages.
   B13. The method of embodiment B12, wherein the network node is a core network node, and the another network node is a radio network node.
   B14. The method of embodiment B13, wherein the core network node implements a User Plane Function, UPF.
   B15. The method of embodiment B12, wherein the network node comprises a central unit of a radio network node and the another network node comprises a distributed unit of the radio network node.
   B16. The method of any of embodiments B1-B11, wherein said transmitting or receiving comprises receiving the messages.
   B17. The method of embodiment B16, wherein the another network node is a core network node, and the network node is a radio network node.
   B18. The method of embodiment B17, wherein the core network node implements a User Plane Function, UPF.
   B19. The method of embodiment B16, wherein the another network node comprises a central unit of a radio network node and the network node comprises a distributed unit of the radio network node.
   B20. The method of any of embodiments B16-B19, further comprising, based on the one or more indicated characteristics of the user plane traffic, adapting allocation of radio resources for the user plane traffic and/or adapting a configuration of a communication device associated with the user plane traffic.
   B21. The method of any of embodiments B1-B20, wherein the one or more messages each further include a quality of service, QoS, flow identifier identifying a QoS flow to which the message or the user plane traffic conveyed by the message belongs.
   B22. The method of any of embodiments B1-B21, wherein the one or more messages each further include other information indicating one or more requirements for conveying the user plane traffic.
   B23. The method of embodiment B22, wherein the messages convey user plane traffic for one or more QoS flows, wherein other information included in a message conveying user plane traffic for a QoS flow indicates the one or more requirements for conveying the user plane traffic for that QoS flow.
   B24. The method of embodiment B23, wherein the other information included in a message conveying user plane traffic for a QoS flow indicates the one or more requirements for conveying the user plane traffic for that QoS flow by indicating an identifier of that QoS flow.
   B25. The method of any of embodiments B1-B24, wherein the messages are downlink messages.
   BB1. A method performed by a network node in a communication network, the method comprising:
transmitting or receiving uplink signaling indicating one or more characteristics of user plane traffic.
   BB2. The method of embodiment BB1, wherein said transmitting or receiving comprises receiving the uplink signaling.
   BB3. The method of embodiment BB2, wherein the uplink signaling is received from a communication device.
   BB4. The method of any of embodiments BB1-BB3, wherein the uplink signaling is received in a radio resource control, RRC, message.
   BB5. The method of embodiment BB4, wherein the RRC message is a UE Assistance message.
   BB6. The method of embodiment BB1, wherein said transmitting or receiving comprises transmitting the uplink signaling.
   BB7. The method of embodiment BB6, wherein the uplink signaling is transmitted to another network node.
   BB8. The method of any of embodiments BB1-BB7, wherein the one or more characteristics include one or more characteristics at an application layer.
   BB9. The method of any of embodiments BB1-BB8, further comprising obtaining the one or more characteristics from an application layer.
   BB10. The method of any of embodiments BB1-BB9, wherein the one or more characteristics include a periodicity of the user plane traffic.
   BB11. The method of any of embodiments BB1-BB10, wherein the one or more characteristics include a burst arrival time of the user plane traffic.
   BB12. The method of any of embodiments BB1-BB11, wherein the one or more characteristics are one or more time-sensitive communication, TSC, characteristics.
   BB13. The method of any of embodiments BB1-BB12, wherein the uplink signaling indicates one or more characteristics of user plane traffic for each of one or more flows.
   BB14. The method of embodiment BB13, wherein the one or more flows are one or more XR traffic flows.
   BB. The method of any of the previous embodiments, further comprising:
obtaining user data; and forwarding the user data to a host computer or a wireless communication device.

### Group C Embodiments

C1. A communication device configured to perform any of the steps of any of the Group A embodiments.
C2. A communication device comprising processing circuitry configured to perform any of the steps of any of the Group A embodiments.
C3. A communication device comprising:
communication circuitry; and
processing circuitry configured to perform any of the steps of any of the Group A embodiments.
   C4. A communication device comprising:
processing circuitry configured to perform any of the steps of any of the Group A embodiments; and
power supply circuitry configured to supply power to the communication device.
   C5. A communication device comprising:
processing circuitry and memory, the memory containing instructions executable by the processing circuitry whereby the communication device is configured to perform any of the steps of any of the Group A embodiments.
   C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.
   C7. A computer program comprising instructions which, when executed by at least one processor of a communication device, causes the communication device to carry out the steps of any of the Group A embodiments.
   C8. A carrier containing the computer program of embodiment C7, wherein the carrier is one of an electronic signal, optical signal, radio signal, or computer readable storage medium.
   C9. A network node configured to perform any of the steps of any of the Group B embodiments.
   C10. A network node comprising processing circuitry configured to perform any of the steps of any of the Group B embodiments.
   C11. A network node comprising:
communication circuitry; and
processing circuitry configured to perform any of the steps of any of the Group B embodiments.
   C12. A network node comprising:
processing circuitry configured to perform any of the steps of any of the Group B embodiments;
power supply circuitry configured to supply power to the network node.
   C13. A network node comprising:
processing circuitry and memory, the memory containing instructions executable by the processing circuitry whereby the network node is configured to perform any of the steps of any of the Group B embodiments.
   C14. The network node of any of embodiments C9-C13, wherein the network node is a base station.
   C15. A computer program comprising instructions which, when executed by at least one processor of a network node, causes the network node to carry out the steps of any of the Group B embodiments.
   C16. The computer program of embodiment C14, wherein the network node is a base station.
   C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.
   D2. The communication system of the previous embodiment further including the base station.
   D3. The communication system of the previous 2 embodiments, further including the UE, wherein the UE is configured to communicate with the base station.
   D4. The communication system of the previous 3 embodiments, wherein:
the processing circuitry of the host computer is configured to execute a host application, thereby providing the user data; and
the UE comprises processing circuitry configured to execute a client application associated with the host application.
   D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.
   D6. The method of the previous embodiment, further comprising, at the base station, transmitting the user data.
   D7. The method of the previous 2 embodiments, wherein the user data is provided at the host computer by executing a host application, the method further comprising, at the UE, executing a client application associated with the host application.
   D8. A user equipment (UE) configured to communicate with a base station, the UE comprising a radio interface and processing circuitry configured to perform any of the previous 3 embodiments.
   D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.
   D10. The communication system of the previous embodiment, wherein the cellular network further includes a base station configured to communicate with the UE.
   D11. The communication system of the previous 2 embodiments, wherein:
the processing circuitry of the host computer is configured to execute a host application, thereby providing the user data; and
the UE's processing circuitry is configured to execute a client application associated with the host application.
   D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.
   D13. The method of the previous embodiment, further comprising at the UE, receiving the user data from the base station.
   D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.
   D15. The communication system of the previous embodiment, further including the UE.
   D16. The communication system of the previous 2 embodiments, further including the base station, wherein the base station comprises a radio interface configured to communicate with the UE and a communication interface configured to forward to the host computer the user data carried by a transmission from the UE to the base station.
   D17. The communication system of the previous 3 embodiments, wherein:
the processing circuitry of the host computer is configured to execute a host application; and
the UE's processing circuitry is configured to execute a client application associated with the host application, thereby providing the user data.
   D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.
   D19. A method implemented in a communication system including a host computer, a base station and a user equipment (UE), the method comprising:
at the host computer, receiving user data transmitted to the base station from the UE, wherein the UE performs any of the steps of any of the Group A embodiments.
   D20. The method of the previous embodiment, further comprising, at the UE, providing the user data to the base station.
   D21. The method of the previous 2 embodiments, further comprising:
at the UE, executing a client application, thereby providing the user data to be transmitted; and at the host computer, executing a host application associated with the client application.
   D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.
   D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
   D24. The communication system of the previous embodiment further including the base station.
   D25. The communication system of the previous 2 embodiments, further including the UE, wherein the UE is configured to communicate with the base station.
   D26. The communication system of the previous 3 embodiments, wherein:
the processing circuitry of the host computer is configured to execute a host application;
the UE is configured to execute a client application associated with the host application, thereby providing the user data to be received by the host computer.
   D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.
   D28. The method of the previous embodiment, further comprising at the base station, receiving the user data from the UE.
   D29. The method of the previous 2 embodiments, further comprising at the base station, initiating a transmission of the received user data to the host computer.

### REFERENCES

1. TS 38.413 v 16.8.0
2. TS 38.415 v 16.6.0
3. TS 38.425 v 16.3.0

1.-43. (canceled)

44. A method performed by a network node in a communication network, the method comprising:
transmitting or receiving messages through a tunnel with another network node, wherein the messages convey user plane traffic, wherein one or more of the messages each include information indicating one or more characteristics of the user plane traffic, wherein the one or more characteristics include a periodicity of the user plane traffic and/or a burst arrival time of the user plane traffic.

45. The method of claim 44, wherein the one or more characteristics are one or more characteristics measured or experienced at an application layer.

46. The method of claim 44, wherein the messages convey user plane traffic for one or more flows, wherein information included in a message conveying user plane traffic for a flow indicates one or more characteristics of the user plane traffic for that flow.

47. The method of claim 46, wherein the user plane traffic is extended Reality (XR) traffic, wherein the one or more flows are one or more XR traffic flows.

48. The method of claim 44, wherein the one or more messages each further include a quality of service (QOS) flow identifier identifying a QoS flow to which the message or the user plane traffic conveyed by the message belongs.

49. The method of claim 44, wherein the tunnel is a General Packet Radio Service (GPRS) Tunnelling Protocol (GTP) user plane (GTP-U) tunnel, wherein the one or more messages each include the information indicating the one or more characteristics of the user plane traffic in a GTP-U extension header.

50. The method of claim 44, wherein the one or more messages each include the information indicating the one or more characteristics of the user plane traffic in:
a DL PDU SESSION INFORMATION frame;
a DL USER DATA frame; or
a DL DATA DELIVERY STATUS frame.

51. The method of claim 44, wherein said transmitting or receiving comprises transmitting the messages, wherein either:
the network node is a core network node and the another network node is a radio network node; or
the network node comprises a central unit of a radio network node and the another network node comprises a distributed unit of the radio network node.

52. The method of claim 44, wherein said transmitting or receiving comprises receiving the messages, wherein either:
the another network node is a core network node and the network node is a radio network node; or
the another network node comprises a central unit of a radio network node and the network node comprises a distributed unit of the radio network node.

53. The method of claim 52, further comprising, based on the one or more indicated characteristics of the user plane traffic, adapting allocation of radio resources for the user plane traffic and/or adapting a configuration of a communication device associated with the user plane traffic.

54. The method of claim 51, wherein the core network node implements a User Plane Function (UPF).

55. A network node configured for use in a communication network, the network node comprising:
communication circuitry; and
processing circuitry configured to transmit or receive messages through a tunnel with another network node, wherein the messages convey user plane traffic, wherein one or more of the messages each include information indicating one or more characteristics of the user plane traffic, wherein the one or more characteristics include a periodicity of the user plane traffic and/or a burst arrival time of the user plane traffic.

56. A method performed by a communication device in a communication network, the method comprising:
transmitting, to the communication network, uplink signaling indicating one or more characteristics of user plane traffic, wherein the one or more characteristics include a periodicity of the user plane and/or include a burst arrival time of the user plane traffic.

57. The method of claim 56, wherein the one or more characteristics are one or more characteristics measured or experienced by the communication device at an application layer.

58. The method of claim 56, further comprising measuring the one or more characteristics at an application layer at the communication device, wherein the signaling indicates the one or more characteristics as measured.

59. The method of claim 56, wherein the uplink signaling indicates the one or more characteristics of user plane traffic for each of one or more flows.

60. The method of claim 59, wherein the one or more flows are one or more quality of service (QOS) flows or one or more extended Reality (XR) traffic flows.

61. The method of claim 56, wherein the uplink signaling is transmitted in a radio resource control (RRC) message.

62. The method of claim 61, wherein the RRC message is a UE Assistance message.

63. A communication device configured for use in a communication network, the communication device comprising:
communication circuitry; and
processing circuitry configured to transmit, to the communication network, uplink signaling indicating one or more characteristics of user plane traffic, wherein the one or more characteristics include a periodicity of the user plane and/or include a burst arrival time of the user plane traffic.
